(19) United States
(12) Patent Application Publication
(10) Pub. No.: US 2007/0003173 A1
(43) Pub. Date: Jan. 4, 2007

(54) Multi-functional bearing for rotating shafts

(76) Inventor: Lindsay Schultz, Vic (AU)

Correspondence Address: KLAUBER & JACKSON, 411 HACKENSACK AVENUE, HACKENSACK, NJ, 07601, US

(21) Appl. No.: 10/546,376

(22) PCT Filed: Feb. 20, 2004
(86) PCT No.: PCT/AU04/00217

§ 371 Date: Jul. 11, 2006

(30) Foreign Application Priority Data
Feb. 21, 2003 (AU) 2003900781

(51) Int. Cl. F16C 33/02

(52) U.S. Cl. 384/276

(57) ABSTRACT

A protective cover (30) for a PTO shaft and a universal joint (now shown). The protective cover includes: (a) a sheath (40) moulded from plastic material, wherein the sheath includes a housing (31) disposed between a sleeve (32) and a skirt (34); (b) a locking ring (33) moulded from plastic material; and (c) a bearing (35) located securely within the housing in rotational communication with the sheath, the bearing including a compressible inner core (5) with a central opening and internal bore (50) extending therefrom, the inner core being surrounded by an external hard shell (6). The external outer shell (6) may contain lubricious material, and the compressible inner core may be substituted for fasteners extending radially inwards from the outer shell, said fasteners engaging against the shaft member so as to secure the shaft internally of the bearing (35).

### FIELD OF THE INVENTION

The present invention relates to safety devices for rotating shafts and in particular a bearing for a rotating shaft in which the bearing is adapted to be mountable on shafts of any cross-section geometry.

### BACKGROUND OF THE INVENTION

In applications where rotating shafts are used to drive machinery for example agricultural or commercial type tractors, rotating shafts have conventionally been used in an exposed condition. In such a condition rotating shafts are exposed to dirt, chaff and may even make contact with the ground, thus giving rise to wearing of components and the need for frequent replacement. Notwithstanding the issue of wear, exposed shafts rotating at a high rate of revolutions creates a hazardous working environment for an operator of such machinery.

It is believed that all agricultural machinery that are equipped with Power take off (PTO) shafts, so as to independently operate an attachment thereto, should be required by legislation to include a non-rotating tube-like shield surrounding the shaft.

However the introduction of safety legislation of a tube-like shield in conventional manner and fabricated from plastic will suffer the drawback of the shield and/or the bearing being exposed to extreme frictional forces thus causing fusion or melting of either or both components.

PTO shafts and indeed any rotatable shaft are supplied in a range of various cross-sectional shapes and configurations. Accordingly a supplier of bearings would need to stock a range of shaped bearings from which an appropriate bearing can be selected to mate in a working condition with a corresponding shaped rotatable shaft. This presents even further problems between rotating shaft components; bearings and protective shields, particularly if the bearing needs to be frequently replaced. In such circumstances a machine which is connected to a rotatable shaft via a universal joint may be out of operation until a suitably matched replacement is supplied.

Even further practical difficulties would be faced by operators of machines having rotating shafts particularly when protective covers need to be removed to gain access to various components. Generally in order to gain access to machinery components, where a protective cover is in use, requires destruction of the cover and complete replacement. This process is labor intensive and costly and often results in non-compliance with current legislation as shafts may be left in an exposed condition for subsequent use.

It is an object of the present invention to address at least one of the above mentioned expected disadvantages.

### SUMMARY OF THE INVENTION

In accordance with the invention there is provided a multi-functional bearing for mounting on a rotatable shaft member, the bearing including:

a hard outer casing wherein the outer casing has an internal and external surface separated by an edge, the casing further having opposite openings and a channel extending therebetween;

one or more fasteners disposed on at least a portion of the internal surface of the outer casing, the fastener(s) extending radially inwardly from the internal surface and enabling passage of the shaft member therethrough;

wherein the fastener(s) engage against the shaft member to secure the shaft within the channel.

The hard outer casing can be lubricious. For example the external surface of the outer casing can include a graphite coating. Alternatively the hard outer casing can be selected from nylon impregnated with molybdenum Disulphide lubricious agent. The outer casing/shell is therefore able to readily rotate with rotation of a shaft member relative to a shroud or tube like shield.

In accordance with the invention there is further provided a multi-functional bearing for mounting on a rotatable shaft member, the bearing includes a hard outer shell with opposing openings and a channel therebetween and having one or more fasteners, the outer surface of the outer shell including lubricious material or structure to allow ready rotation of a structure such as a tube like shield or a shroud relative to the rotatable shaft member; the fasteners extending from the hard outer shell and into the channel wherein upon insertion of a rotatable shaft through the opening into the channel of the hard outer shell, the fasteners are extending radially between the hard shell and engage against the shaft member so as to secure the shaft internally of the bearing.

The fasteners can be adjustable to allow adjustable engagement to any one of a plurality of different sized and shaped shafts inserted into the channel of the hard outer shell.

The fasteners can be detachably adjustable to allow adjustable engagement to any one of a plurality of different sized and shaped shafts inserted into the channel of the hard outer shell and ready detachment to allow removal or replacement when required.

The fasteners can be fitting structures adjustable to allow adjustable engagement to any one of a plurality of different sized and shaped shafts inserted into the channel of the hard outer shell. However in another form the fasteners are fitting material malleable and or settable to allow adjustable engagement to any one of a plurality of different sized and shaped shafts inserted into the channel of the hard outer shell.

The outer shell of the multi-functional bearing can include a surface layer of a lubricous substance such as granular or powdered graphite on its external surface to assist continuous free sliding movement, during high speed rotation, between the bearing and a surface adjacent to and supported by the bearing. The outer shell is in one form a ring structure formed from a composition of molybdenum disulphide impregnated nylon. The ring structure can include a series of paddles extending radially inwardly from the internal surface, said paddles being evenly spaced to allow greater adhesion of the inner core to the internal surface of the ring structure and thus prevent the inner core from being a turning surface.

Also in accordance with the invention there is provided a multi-functional bearing for mounting on a rotatable shaft member, the bearing includes: a hard outer shell with opposing openings and a channel therebetween filled with a resiliently compressible core; the resilient core includes an opening allowing a bore to extend therefrom; wherein upon insertion of a rotatable shaft through the opening into the bore, the core is displaced compressively radially outwards towards the hard shell and is thereafter resiliently biased against the shaft so as to secure the shaft internally of the bearing.

The advantage of the present invention is that the inner core of the bearing is displaceable as a rotatable shaft is inserted and moved through the bore. In this way the inner core of the bearing can accommodate a shaft of any cross-sectional shape or configuration that is capable of being rotated. A further advantage of the present invention is that once a rotatable shaft is received within the bearing structure, the bearing is secured from hazardous detachment by the action of the inner core against the shaft following radial compression.

Without wishing to be unduly limiting a person of skill in the art would be aware that the bearing of the instant invention is applicable to any rotating shaft, but particularly finds use for PTO shafts.

The opening and bore within the resilient compressible inner core can be narrower than the corresponding diameter or width of a shaft which is inserted through the opening. The bore can be of constant circular cross section. The core can further include a fissure(s) or a cleft(s) extending radially outwardly from the bore so that the core can more readily be displaced to accommodate shafts of different cross-sectional size and geometry. The bearing can be of any geometry, although for practical reasons the bearing is usually shaped in the form of a ring structure or cylinder.

The bore can be tapered along at least a part of its length. In particular the taper can extend from a relatively wide opening to a smaller bore to enable ready insertion of a rotatable shaft within the bearing. The bore can be of circular cross-section, although the applicant has found that when the bore includes at least one longitudinal fissure extending radially from the bore, the bore can more readily accommodate different shaped rotatable shafts. The bearing is generally understood to be of circular cross-section and fabricated in lengths or sections for positioning over a corresponding shaft.

The resiliently compressible inner core and the outer shell can be formed as a single integral component. Conversely it is understood that the bearing can be fabricated from a two component assembly. In this case the inner compressible core can be attached to the inner surface of the outer shell by means of conventional adhesive.

The bearing can also be a split bearing in which case the components of the bearing include interengaging mating means to enable retrofitting over exposed shafts. The mating means can include female and male components such as mating dovetail joints connecting the split bearing components together. The hard outer shell can include a seam about which two halves of the bearing can pivot to enable opening and closing of the bearing about a rotatable shaft. Alternatively the outer shell can be adapted to fold about itself to enclose a shaft.

The outer shell can include a surface layer of a lubricous substance such as granular or powdered graphite on its external surface. The incorporation of graphite on a surface of the bearing encourages continuous free sliding movement, during high speed rotation, between the bearing and a surface adjacent to and supported by the bearing. Alternatively the outer shell can be a ring structure formed from a composition of molybdenum disulphide impregnated nylon. The ring structure has an internal and external surface separated by an edge. The ring structure can further include a series of paddles extending radially inwardly from the internal surface. The paddles can be evenly spaced to allow greater adhesion of the inner core to the internal surface of the ring structure and thus prevent the inner core from being a turning surface.

The resiliently compressible inner core component can be fabricated from a high density foam composition including but not limited to foam rubber or polyurethane foam or the like. And the hard outer shell can be selected from materials such as polypropylene and other conventional thermosetting plastics which can incorporate a lubricious component or have a surface coating of a lubricious compound.

The invention also provides a protection system for a rotatable shaft member and connected rotating parts of a vehicle, including a multi-functional bearing and a protective shield;
the multi-functional bearing for mounting on a rotatable shaft member having a hard outer shell with opposing openings and a channel therebetween and having one or more fasteners, with the outer surface of the outer shell including lubricious material or structure;
the protective shield having a first shape to substantially surround at least a portion of the rotatable shaft member and connected rotating parts of a vehicle and a second part for mounting on the multi-functional bearing to allow ready rotation of the protective shield relative to the rotatable shaft member;
and further including fasteners extending from the hard outer shell and into the channel wherein upon insertion of a rotatable shaft through the opening into the channel of the hard outer shell, the fasteners are extending radially between the hard shell and engage against the shaft member so as to secure the shaft member internally of the bearing.

The present invention further includes a protective cover for a rotatable shaft, the protective cover including:

a multifunctional bearing having an external hard lubricious shell and a resiliently compressible inner core, wherein the inner core includes a centrally disposed bore for mounting the bearing on to a rotatable shaft and thereafter so the bearing is static relative to the shaft as the inner core is biased against the shaft;

a non-rotating sheath adapted to substantially encase the bearing; the sheath having an internal housing for locating the multifunctional bearing therewithin;

a locking means for securing the bearing within the housing in rotatable relation therewith;

wherein the bearing rotates within the housing as the shaft turns and an operator is substantially protected.

In an operating condition the bearing rotates within the housing and acts as a supporting surface for the sheath.

The protective sheath can include (a) a cylindrical sleeve extending from one side of the housing for receiving a pipe or like cover means which is adapted to enclose a length of exposed rotatable shaft; and (b) an oppositely disposed skirt depending from the housing for receiving a universal joint.

The housing can include a series of openings adjacent the skirt for receiving the locking means in mating relation. The locking means can be a ring assembly having a series of wedge-shaped members extending therefrom, wherein the wedge-shaped members include a recess forming a shoulder at or close to one edge thereof and the housing includes mating openings adjacent the skirt so that in a locking condition the wedge-shaped members extend through the openings until the shoulder portions engage a surface of the skirt thereby securely locating the bearing within the housing.

The housing can include an internal annular flange or shoulder on which the edge of the bearing abuts in an operating or locked condition. In this arrangement the shoulder or flange can also define a recess within the sleeve which acts as a stop for both receiving and locating a pipe adjacent to the bearing housing. The sleeve can also include an external flange which acts as a stop for different size pipe fittings mounted externally of the sleeve.

The bearing can include an outer ring structure formed from a composition of molybdenum disulphide impregnated nylon and an inner resiliently compressible core fastened to the ring structure. The ring structure has an internal and external surface separated by an edge.

The protective cover can include a locking ring for securing the bearing within the housing. The locking ring can include a series of wedge-shaped members having a recess forming a shoulder at or close to one edge, and the housing includes mating openings adjacent the skirt so that the wedge-shaped members extend through the openings and the shoulders abut a surface of the skirt to secure the bearing within the housing.

The locking ring can include a locating or retaining ring which can be linked to a piece of machinery remote from the protective cover to assist in maintaining the locking ring in a particular orientation. The retaining ring can be so linked by a length of chain.

Still further the invention provides a method of protection of a rotatable shaft member and connected rotating parts on a vehicle including the steps of:
providing a multi-functional bearing for mounting on a rotatable shaft member having a hard outer shell with opposing openings and a channel therebetween and having one or more fasteners, with the outer surface of the outer shell including lubricious material or structure;
providing a protective shield having a first shape to substantially surround at least a portion of the rotatable shaft member and connected rotating parts of a vehicle and a second part for mounting on the multi-functional bearing to allow ready rotation of the protective shield relative to the rotatable shaft member;
and providing fasteners extending from the hard outer shell and into the channel wherein upon insertion of a rotatable shaft through the opening into the channel of the hard outer shell, the fasteners are extending radially between the hard shell and engage against the shaft member so as to secure the shaft member internally of the bearing.

The fasteners can be adjustable to allow adjustable engagement to any one of a plurality of different sized and shaped shafts inserted into the channel of the hard outer shell.

The fasteners can be detachably adjustable to allow adjustable engagement to any one of a plurality of different sized and shaped shafts inserted into the channel of the hard outer shell and ready detachment to allow removal or replacement when required.

### BRIEF DESCRIPTION OF THE DRAWINGS

In order that the invention is more readily understood embodiments of the invention will be described by way of illustration only with reference to the drawings wherein:

FIG. 1A is a plan view of a bearing according to one embodiment of a protection system of the present invention for a rotatable shaft member and connected rotating parts of a vehicle;

FIG. 1B is a cross-section of the bearing component of FIG. 1A through section A-A;

FIG. 2 is a plan view of one half of a split bearing in accordance with the present invention;

FIG. 3A is an end (plan) view from position “A” of a protective cover according to one embodiment of the present invention;

FIG. 3B is a cross-section of view of the protective cover of FIG. 3A;

FIG. 4A is an end (plan) view from position ‘A’ of a sheath component;

FIG. 4B is a cross-sectional view of the sheath component of FIG. 4A through section x-x;

FIG. 5A is a plan view of a locking ring according to the invention;

FIG. 5B is a side view of the locking ring according to FIG. 5A;

FIG. 6A is an end plan view of the sheath shown in FIG. 4B from position ‘B’ without a locking ring;

FIG. 6B is a partial side view of the sheath according to FIG. 6A;

FIG. 7A is an end plan view of a protective cover from position “A” illustrated in accordance with FIG. 3B;

FIG. 7B is a cross sectional view of the protective cover illustrated in FIG. 7A through y-y′.

### DETAILED DESCRIPTION OF A PREFERRED EMBODIMENT OF THE INVENTION WITH REFERENCE TO THE DRAWINGS

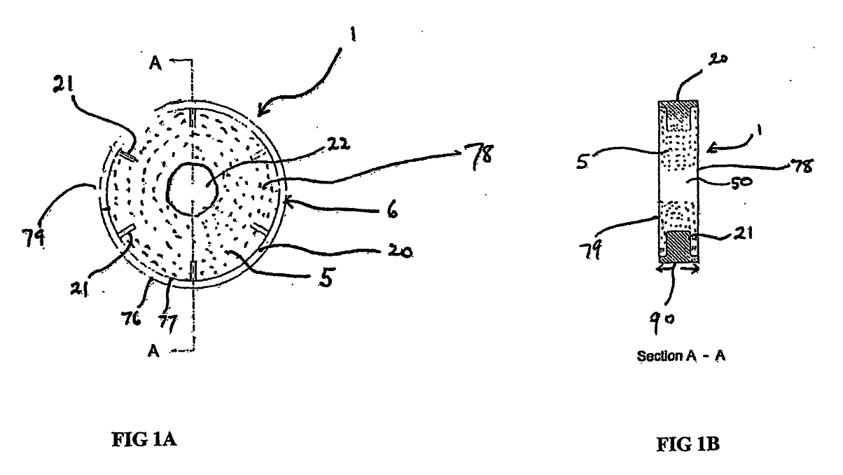

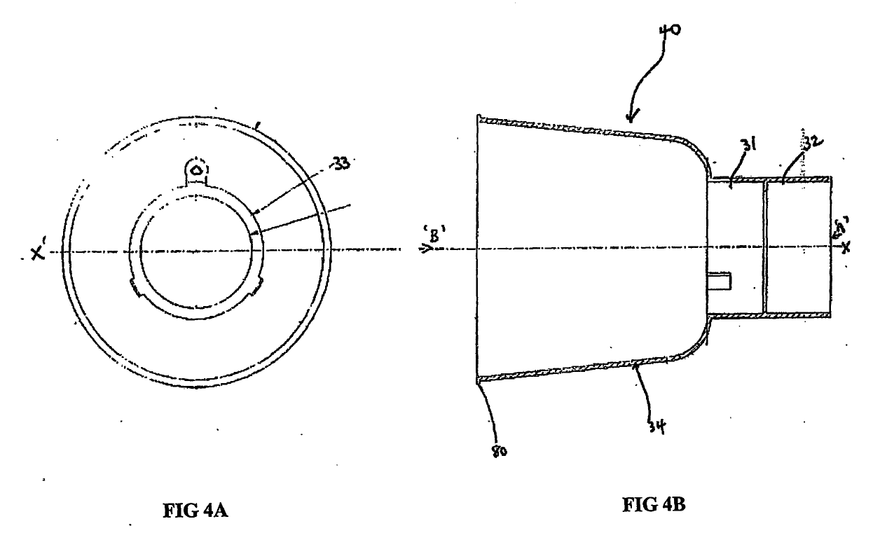

With reference to FIGS. 1A and 1B there is shown a multi-functional bearing (1) in accordance with the present invention. The bearing (1) includes an outer shell or casing (6) in the form of a ring structure which surrounds a resiliently compressible inner core (5). The ring structure of the outer shell has an external surface (76) and an internal surface (77) separated by an edge (20) and has opposite openings (78 and 79) between which a channel is formed extending the width of the ring (90). The ring is made from nylon impregnated with a lubricious agent selected from molybdenum disulphide. The external surface of the ring is adapted to both bear against and rotate within a static outer protective sheath (best seen in FIG. 4B). The combination of nylon impregnated with molybdenum disulphide substantially minimizes excessive friction build up within the protective sheath which can otherwise result in fusion.

The ring structure includes a series of evenly spaced apart paddles (21) extending radially inwardly from the internal surface (77). The paddles act as points of attachment for the inner core as well as reinforcing the structural integrity of the bearing. The inner core is fastened to the internal surface of the ring by conventional adhesive. The inner core (5) is made from a resiliently compressible material selected from foamed rubber or polyurethane foam or the like, which can be compressed and resiliently biased to engage against a rotatable shaft member.

The inner core includes first and second opposing openings (22) and a bore (50) extends between the openings to accommodate a rotatable shaft (not shown). The diameter of the openings in the inner core and the bore therebetween is generally smaller than the corresponding diameter of a rotatable shaft so that the inner core is compressively displaced towards the internal surface of the outer ring structure as the shaft is inserted through one opening into the bore. Once the bearing is mounted onto a shaft (not shown), the resilient core is biased against the shaft so that the bearing engages the shaft and does not exhibit movement relative to a turning shaft. In order to help facilitate ready fitting of the bearing over a shaft, the bore can be tapered or even contain fissures (not shown) starting from a surface of the bore extending towards the outer ring structure.

It is to be understood that a shaft of any cross-sectional configuration is able to be accommodated by the bearing of the invention. For example in the embodiments shown, the openings and bore of the inner core have a circular cross-section but are able to accommodate a shaft of significantly different cross-sectional geometry.

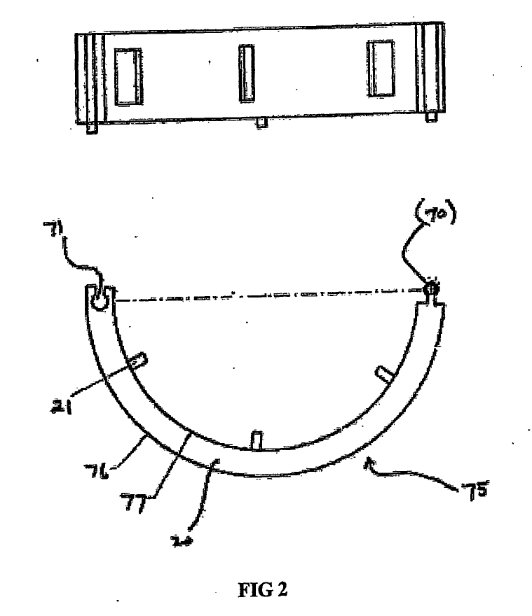

Turning to FIG. 2 there is shown an example of how a bearing and in particular the hard outer shell of the present invention can be split to enable retrofitting to existing machinery. FIG. 2 shows one half of a split bearing (75) in which there is illustrated male (70) and female (71) elements for dovetailing with mating elements of another semi-circular section to form a complete ring structure. Alternatively the ring structure of the bearing in FIG. 2 can be formed in such a way that it incorporates an overlapping portion which can be resiliently adjusted by manually opening and closing for mounting the bearing about a rotatable shaft. In addition to split bearings, split pipes can be used to fit over an existing length of rotatable shaft.

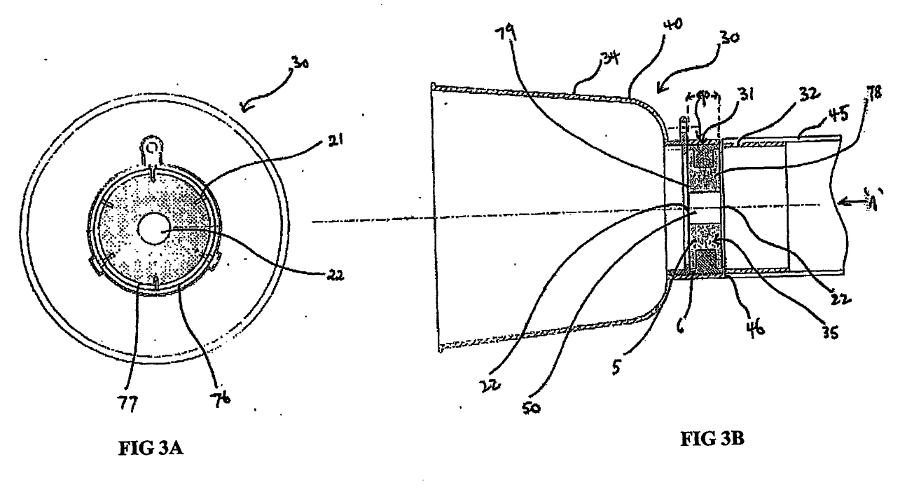

Referring to FIGS. 3A, 3B, 4A, 4B, 7A and 7B there is shown a protective cover (30) for a PTO shaft and a universal joint (not shown). The protective cover includes:
(a) a sheath (40) moulded from a plastics material, wherein the sheath includes a housing (31) disposed between a sleeve (32) and a skirt (34);
(b) a locking ring (33) moulded from plastic material; and
(c) a bearing (35) located securely within the housing in rotational communication with the sheath, the bearing including a compressible inner core (5) with a central opening and internal bore (50) extending therefrom, the inner core being surrounded by an external hard shell (6).

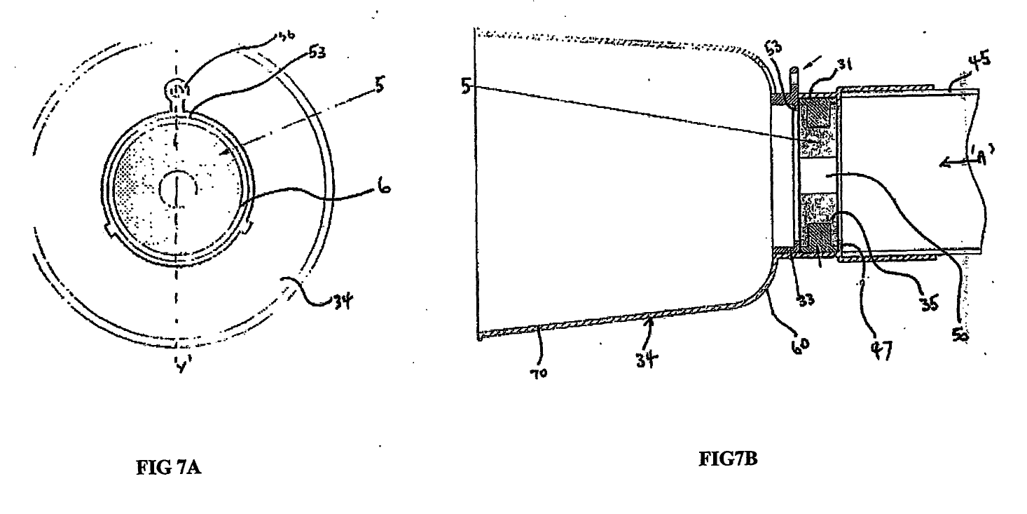

In an assembled condition as shown in FIG. 7B the bearing (1) is retained within housing (31) of the protective sheath (40). In an operating condition the bearing (1) rotates within the housing in engagement relation with a rotating shaft (not shown). The bearing thus turns relative to and bears against the housing while the protective sheath is static. As a PTO shaft or the like shaft rotates, the external surface of the ring structure (6) of the bearing makes frictional contact with the protective sheath. The composition of the ring structure allows the bearing to effectively freely slide in frictional contact with the housing without substantial heat generation that has caused prior art devices to breakdown.

The sheath (40) as illustrated with reference to FIG. 4B includes a cylindrical sleeve (32) which is adapted to receive an elongate pipe (45) either internally or externally. As an example in FIG. 3B a pipe (45) is illustrated mounted externally of the sleeve and abutting a shoulder (46). Alternatively as shown in FIG. 7B, a pipe (45) can be mounted internally of the sleeve (32) coming to rest against an internal annular shoulder (47).

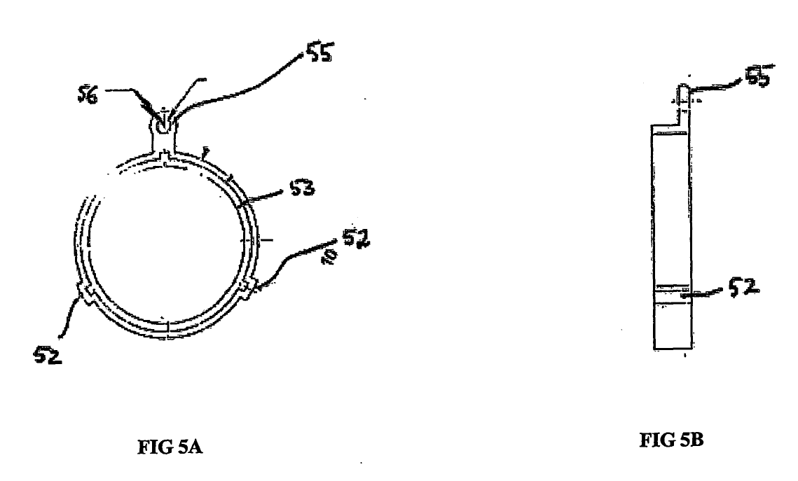

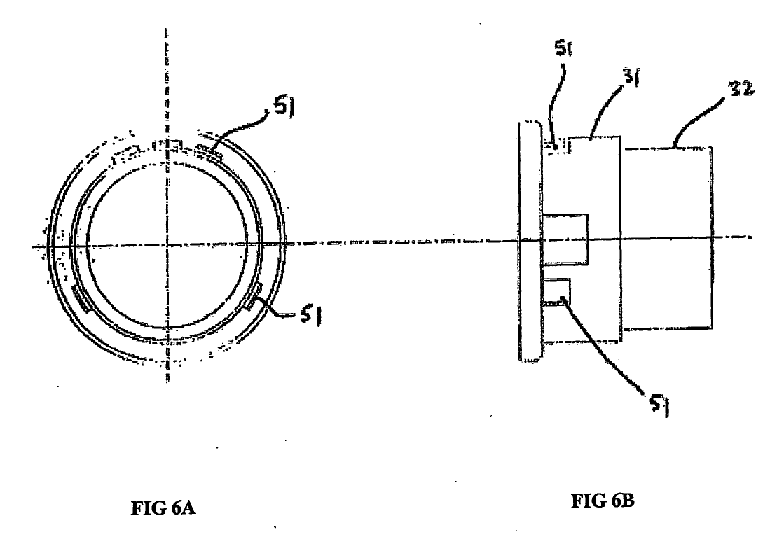

Referring to FIG. 6 the sheath includes a housing (31) disposed between an internal shoulder (47 or 46) of the sleeve and the skirt (34), which is adapted to receive and locate the bearing. The housing includes spaced openings (51) adjacent to the skirt to receive mating protrusions (52) on the locking ring (shown in FIG. 5). Turning to FIG. 5, the locking ring includes four wedge-shaped protrusions (52), (of which only two are illustrated) which extend through the openings (51) in the housing. The protrusions (52) include a recess (not shown) forming a shoulder, which rest on an external surface of the skirt when in a locked condition. The locking ring also includes an internal flange (53), which together with the internal shoulder (46 or 47) defines a part of the housing for locating the bearing (1). The locking ring further includes a chain lug (55) with an opening (56) therein, which acts as a safety anchoring point to assist in substantially eliminating any inadvertent rotational movement experienced by the protective cover when exposed to a rotating shaft. In one embodiment (not shown) a chain can be used to connect to the chain lug directly to a non-movable external part to maintain the orientation of the locking ring.

Referring to FIGS. 4B and 7B, the skirt (34) includes an annular arcuate section (60) extending from the housing, ending in an annular wall (70), which diverges at an acute angle to the line X-X′ (see FIG. 4B). The area defined by the skirt is adapted to receive a universal joint (not shown). The skirt ends in a rim (80) which allows the skirt to abut against another surface and thereby enclose a universal joint.

Further embodiments of the invention would be understood by persons skilled in the art with reference to the accompanying above description without any inventiveness and without departing from the spirit of the invention and such are included within the scope of the invention as defined in the following claims.

1. A multi-functional bearing for mounting on a rotatable shaft member, the bearing includes:
a hard outer shell with opposing openings and a channel therebetween and having one or more fasteners,
the outer surface of the outer shell including lubricious material or structure to allow ready rotation of a structure such as a tube like shield or a shroud relative to the rotatable shaft member;
the fasteners extending from the hard outer shell and into the channel wherein upon insertion of a rotatable shaft through the opening into the channel of the hard outer shell, the fasteners are extending radially between the hard shell and engage against the shaft member so as to secure the shaft internally of the bearing.

2. A multi-functional bearing for mounting on a rotatable shaft member according to claim 1 wherein the fasteners are adjustable to allow adjustable engagement to any one of a plurality of different sized and shaped shafts inserted into the channel of the hard outer shell.

3. A multi-functional bearing for mounting on a rotatable shaft member according to claim 1 wherein the fasteners are detachably adjustable to allow adjustable engagement to any one of a plurality of different sized and shaped shafts inserted into the channel of the hard outer shell and ready detachment to allow removal or replacement when required.

4. A multi-functional bearing for mounting on a rotatable shaft member according to claim 1 wherein the fasteners are fitting structures adjustable to allow adjustable engagement to any one of a plurality of different sized and shaped shafts inserted into the channel of the hard outer shell.

5. A multi-functional bearing for mounting on a rotatable shaft member according to claim 1 wherein the fasteners are fitting material malleable and or settable to allow adjustable engagement to any one of a plurality of different sized and shaped shafts inserted into the channel of the hard outer shell.

6. A multi-functional bearing according to claim 1 wherein the outer shell includes a surface layer of a lubricous substance such as granular or powdered graphite on its external surface to assist continuous free sliding movement, during high speed rotation, between the bearing and a surface adjacent to and supported by the bearing.

7. A multi-functional bearing according to claim 1 wherein the outer shell is a ring structure formed from a composition of molybdenum disulphide impregnated nylon.

8. A multi-functional bearing according to claim 7 wherein the ring structure includes a series of paddles extending radially inwardly from the internal surface, said paddles being evenly spaced to allow greater adhesion of the inner core to the internal surface of the ring structure and thus prevent the inner core from being a turning surface.

9. A multi-functional bearing for mounting on a rotatable shaft member, the bearing includes:
a hard outer shell with opposing openings and a channel therebetween filled with a resiliently compressible core;
the resilient core includes an opening allowing a bore to extend therefrom;
wherein upon insertion of a rotatable shaft through the opening into the bore, the core is displaced compressively radially outwards towards the hard shell and is thereafter resiliently biased against the shaft so as to secure the shaft internally of the bearing.

10. A multi-functional bearing according to claim 9 wherein the opening and bore within the resilient compressible inner core is narrower than the corresponding diameter or width of a shaft which is inserted through the opening.

11. A multi-functional bearing according to claim 9 wherein the bore further includes a fissure(s) or a cleft(s) extending radially outwardly from the bore so that the core can be readily displaced to accommodate shafts of different cross-sectional size and geometry.

12. A multi-functional bearing according to claim 9 wherein the bore can be tapered along at least a part of its length

13. A multi-functional bearing according to claim 9 wherein the outer shell includes a surface layer of a lubricous substance such as granular or powdered graphite on its external surface to assist continuous free sliding movement, during high speed rotation, between the bearing and a surface adjacent to and supported by the bearing.

14. A multi-functional bearing according to claim 9 wherein the outer shell is a ring structure formed from a composition of molybdenum disulphide impregnated nylon.

15. A multi-functional bearing according to claim 14 wherein the ring structure includes a series of paddles extending radially inwardly from the internal surface, said paddles being evenly spaced to allow greater adhesion of the inner core to the internal surface of the ring structure and thus prevent the inner core from being a turning surface.

16. A protection system for a rotatable shaft member and connected rotating parts of a vehicle, including a multi-functional bearing and a protective shield;
the multi-functional bearing for mounting on a rotatable shaft member having a hard outer shell with opposing openings and a channel therebetween and having one or more fasteners, with the outer surface of the outer shell including lubricious material or structure;
the protective shield having a first shape to substantially surround at least a portion of the rotatable shaft member and connected rotating parts of a vehicle and a second part for mounting on the multi-functional bearing to allow ready rotation of the protective shield relative to the rotatable shaft member;
and further including fasteners extending from the hard outer shell and into the channel wherein upon insertion of a rotatable shaft through the opening into the channel of the hard outer shell, the fasteners are extending radially between the hard shell and engage against the shaft member so as to secure the shaft member internally of the bearing.

17. A protective cover for a rotatable shaft, the protective cover including:
a multifunctional bearing having an external hard lubricious shell and a resiliently compressible inner core, wherein the inner core includes a centrally disposed bore for enabling the bearing to be mounted on to a rotatable shaft so that the bearing is static relative to the shaft;
a non-rotating sheath adapted to substantially encase the bearing; the sheath having an internal housing for locating the multifunctional bearing therewithin;
a locking means for securing the bearing within the housing in rotatable relation therewith;
wherein the bearing rotates within the housing as the shaft turns and an operator is substantially protected.

18. A protective cover for a rotating shaft according to claim 17 wherein the housing is disposed between a sleeve member for receiving a pipe or the like; and a dependent skirt for receiving a universal joint.

19. A protective cover for a rotating shaft according to claim 18 wherein the locking ring includes a series of wedge-shaped members having a recess forming a shoulder at or close to one edge and the housing includes mating openings adjacent the skirt so that in a locked condition the wedge-shaped members extend through the openings and the shoulder(s) engage a portion of the skirt to secure the bearing within the housing.

20. A protective cover for a rotating shaft according to claim 19 wherein the locking ring includes a chain lug for connecting to external machinery to maintain the orientation of the locking ring relative to the housing.

21. A protective cover for a rotating shaft according to claim 17 wherein the sheath includes an internal flange which separates the sleeve and the housing and acts as a stop for the bearing.

22. A protective cover for a rotating shaft according to claim 21 wherein the locking ring includes a shoulder such that when the ring adopts a locked condition an area within the housing is defined between the shoulder and the internal flange within which the bearing is retained.

23. A method of protection of a rotatable shaft member and connected rotating parts on a vehicle including the steps of:
providing a multi-functional bearing for mounting on a rotatable shaft member having a hard outer shell with opposing openings and a channel therebetween and having one or more fasteners, with the outer surface of the outer shell including lubricious material or structure;
providing a protective shield having a first shape to substantially surround at least a portion of the rotatable shaft member and connected rotating parts of a vehicle and a second part for mounting on the multi-functional bearing to allow ready rotation of the protective shield relative to the rotatable shaft member;
and providing fasteners extending from the hard outer shell and into the channel wherein upon insertion of a rotatable shaft through the opening into the channel of the hard outer shell, the fasteners are extending radially between the hard shell and engage against the shaft member so as to secure the shaft member internally of the bearing.

24. A method of protection of a rotatable shaft member and connected rotating parts on a vehicle according to claim 23 wherein the fasteners are adjustable to allow adjustable engagement to any one of a plurality of different sized and shaped shafts inserted into the channel of the hard outer shell.

25. A method of protection of a rotatable shaft member and connected rotating parts on a vehicle according to claim 23 wherein the fasteners are detachably adjustable to allow adjustable engagement to any one of a plurality of different sized and shaped shafts inserted into the channel of the hard outer shell and ready detachment to allow removal or replacement when required.

26. A multi-functional bearing for mounting on a rotatable shaft member, the bearing including:
a hard outer casing wherein the outer casing has an internal and external surface separated by an edge, the casing further having opposite openings and a channel extending therebetween;
one or more fasteners disposed on at least a portion of the internal surface of the outer casing, the fastener(s) extending from the hard outer casing into the channel and enabling passage of the shaft member therethrough;
wherein the fastener(s) engage against the shaft member to secure the shaft within the channel.

27. (canceled)

28. (canceled)

29. A protective cover for a rotatable shaft, the protective cover including:
a multifunctional bearing having a hard lubricious shell, the shell including an internal and external surface separated by an edge and opposing openings forming a channel therebetween, said outer shell further including a series of spaced apart paddles; and a resiliently compressible inner core attached to the outer shell via said paddles, said inner core extending from the internal surface of the outer shell into the channel, wherein the inner core includes first and second oppositely disposed openings defining a bore which receives and allows passage of the rotatable shaft therethrough, the inner core being biased against the shaft in static relation after passage of the shaft through said bore;
a non-rotating sheath having an internal housing for locating the multifunctional bearing therewithin, said housing being disposed between a sleeve member for receiving a pipe or the like; and an oppositely extending dependent skirt for receiving a universal joint, the housing including spaced openings adjacent the skirt; and
a locking ring for securing the bearing within the housing in rotatable relation therewith, the locking ring having an internal and external surface separated by an edge, the ring including a series of wedge-shaped members on the external surface, said wedged shaped members having a recess at or close to the edge forming a shoulder so that in a locked condition the wedge-shaped members extend through the corresponding spaced openings and the shoulder(s) engage against a portion of the skirt to secure the bearing within the housing.

30. A protective cover for a rotating shaft according to claim 29 wherein the locking ring includes a chain lug for connecting to external machinery to maintain the orientation of the locking ring relative to the housing.

31. A protective cover for a rotating shaft according to claim 29 wherein the sheath includes an internal flange which separates the sleeve and the housing and acts as a stop for the bearing.

32. A protective cover for a rotating shaft according to claim 29 wherein the locking ring includes a shoulder such that when the ring adopts a locked condition an area within the housing is defined between the shoulder and the internal flange within which the bearing is retained.

33. A protection system for use on or about a rotatable shaft member including:
a split bearing mountable on a rotatable shaft member, the bearing comprising:
an outer collar of hard lubricious material, wherein the collar is formed from at least a first and second releasably interconnectable elements; and
a resiliently compressible inner core, wherein the inner core includes a centrally disposed bore for mounting the bearing on to a rotatable shaft of any cross-sectional geometry;
a substantially cylindrical split bearing housing having an internal recess portion for receiving the split bearing in a rotational condition, the recess portion ending in a circumferential flange; and
a longitudinal hollow substantially cylindrical protective sheath wherein the sheath is sized to receive the recessed portion of the split bearing and wherein the circumferential flange of the housing abuts a circumferential edge portion of the protective sheath in an assembled condition.

34. The protective system according to claim 33 wherein the protective sheath includes two longitudinal semi-circular molded structures which have mating interlockable elements.

35. The protective system according to claim 33 wherein the split bearing housing comprises two symmetrical elements which include oppositely disposed externally mounted mating elements to allow releasable interconnection of the two elements.

36. The protective system according to claim 33 wherein the split bearing housing further includes a sleeve member extending from the circumferential flange in an opposite direction to the internal recess whereby the sleeve member has a diameter greater than the diameter of the internal recess.

37. The protective system according to claim 36 wherein the sleeve member further includes a series of oppositely disposed openings ending in a second circumferential flange member.
